(19) United States
(12) Patent Application Publication
(10) Pub. No.: US 2011/0012885 A1
(43) Pub. Date: Jan. 20, 2011

(54) LIQUID CRYSTAL DISPLAY DEVICE

(76) Inventors: Masaaki Saitoh, Osaka (JP); Tomoo Furukawa, Osaka (JP); Kazuyoshi Fujioka, Osaka (JP); Katsuya Ogawa, Osaka (JP); Koki Hongo, Osaka (JP)

Correspondence Address: NIXON & VANDERHYE, PC, 901 NORTH GLEBE ROAD, 11TH FLOOR, ARLINGTON, VA, 22203, US

(21) Appl. No.: 12/920,503

(22) PCT Filed: Feb. 26, 2009
(86) PCT No.: PCT/JP2009/000853

§ 371 Date: Sep. 1, 2010

(30) Foreign Application Priority Data
Mar. 4, 2008 (JP) 2008-063433

(51) Int. Cl. G09G 5/00; G09G 3/36

(52) U.S. Cl. 345/211; 345/87

(57) ABSTRACT

In a transflective type liquid crystal display device of a vertical alignment mode in which liquid crystal domains exhibiting axisymmetric orientations are created, a difference in response speed between a region which presents display in the transmission mode and a region which presents display in the reflection mode is reduced.

A liquid crystal display device according to the present invention includes a first substrate and a second substrate and a vertical-alignment type liquid crystal layer interposed therebetween, and has a plurality of pixel regions. The first substrate has a wall-like structure in regular arrangement on the liquid crystal layer side, and the liquid crystal layer forms at least one liquid crystal domain in a region substantially surrounded by the wall-like structure when a predetermined voltage is applied across the liquid crystal layer, the at least one liquid crystal domain exhibiting an axisymmetric orientation. In a region corresponding to the substantial center of the at least one liquid crystal domain, the second substrate includes at least one orientation restriction structure exhibiting an orientation restriction force for placing liquid crystal molecules in an axisymmetric orientation at least under an applied voltage. Each pixel region has first and second transmission regions which present display in a transmission mode and a reflection region which presents display in a reflection mode. The first transmission region is disposed so as to contain the at least one orientation restriction structure, and the second transmission region is disposed along the inner edge of the wall-like structure. The reflection region is disposed between the first transmission region and the second transmission region.

### TECHNICAL FIELD

The present invention relates to a liquid crystal display device, and in particular to a liquid crystal display device which is suitably used in mobile information terminals (e.g., PDAs), mobile phones, liquid crystal displays for vehicle mounting, digital cameras, personal computers, amusement devices, television sets, and the like.

### BACKGROUND ART

In recent years, on the strength of being thin and having a low power consumption, liquid crystal display devices are broadly used in laptop-type personal computers, mobile phones, information devices such as electronic organizers, camera-integrated VTRs having a liquid crystal monitor, and the like.

As a display mode which can realize a high contrast and a wide viewing angle, a vertical alignment mode utilizing a vertical-alignment type liquid crystal layer is drawing attention. In general, a vertical-alignment type liquid crystal layer is formed by using a liquid crystal material having negative dielectric anisotropy and vertical alignment films.

Patent Document 1 proposes a vertical alignment mode called a CPA (Continuous Pinwheel Alignment) mode. In the CPA mode, apertures and recesses are formed in one of a pair of electrodes opposing each other via a liquid crystal layer, and liquid crystal molecules are placed in a radially-inclined orientation (axisymmetric orientation) by using oblique electric fields which are generated at the edge portions of the apertures and recesses, thus realizing a wide viewing angle.

Patent Document 2 discloses a technique of stabilizing the axisymmetric orientation of liquid crystal molecules in the CPA mode. According to the technique of Patent Document 2, the axisymmetric orientation which is created by orientation restriction structures (electrodes having apertures and recesses, which generate oblique electric fields) provided on one substrate is stabilized by orientation restriction structures (e.g., protrusions) which are provided on the other substrate.

Furthermore, Patent Document 3 discloses a technique of realizing a stable axisymmetric orientation with a simple construction. According to the technique of Patent Document 3, liquid crystal domains exhibiting axisymmetric orientations are created within a region that is surrounded by a wall-like structure which is in regular arrangement.

On the other hand, in recent years, a liquid crystal display device which is capable of high-quality displaying in both outdoor and indoor situations has been proposed (e.g., Patent Documents 4 and 5), and is used in electronic equipment for mobile use, e.g., mobile phones, PDAs, and hand-held game machines. This liquid crystal display device, which is referred to as a transflective type (or transmission/reflection combination type) liquid crystal display device, has a reflection region which presents display in a reflection mode and a transmission region which presents display in a transmission mode, both within the pixel.

An ECB mode, a TN mode, and the like are used for transflective type liquid crystal display devices which are commercially available at present. Patent Document 3, supra, discloses a construction in which the vertical alignment mode is applied not only to a transmission type liquid crystal display device but also to a transflective type liquid crystal display device.

An example of a conventional transflective type liquid crystal display device having a wall-like structure is shown in FIG. 12. FIG. 12(a) is a plan view schematically showing the structure of one pixel region of a conventional transflective type liquid crystal display device 500, and FIG. 12(b) is a cross-sectional view along line 12B-12B′ in FIG. 12(a).

The liquid crystal display device 500 includes a TFT substrate 510, a counter substrate 520 opposing the TFT substrate 510, and a vertical-alignment type liquid crystal layer 530 provided between the TFT substrate 510 and the counter substrate 520. Moreover, the liquid crystal display device 500 includes a plurality of pixel regions which are arranged in a matrix array. Each pixel region is defined by a pixel electrode 512 provided on the TFT substrate 510 and a counter electrode 524 which is provided on the counter substrate 520 and opposes the pixel electrode 512 via the liquid crystal layer 530.

In addition to the aforementioned pixel electrode 512, the TFT substrate 510 includes a thin film transistor (TFT) electrically connected to the pixel electrode 512, a scanning line for supplying a scanning signal to the TFT, a signal line for supplying a display signal to the TFT, and the like (none of which is shown). These component elements are formed on the transparent substrate 511. Moreover, the pixel electrode 512 includes a transparent electrode 512t which is made of a transparent electrically conductive material such as ITO and a reflection electrode 512r made of a metal material having a high light reflectance, e.g., aluminum. The reflection electrode 512r is formed on a dielectric layer 513, as will be described later.

In addition to the aforementioned counter electrode 524, the counter substrate 520 includes color filters 522 and a black matrix 523 provided between adjoining color filters 522. These component elements are formed on the transparent substrate 521.

On a surface of each of the TFT substrate 510 and the counter substrate 520 that faces the liquid crystal layer 530, a vertical alignment film (not shown) is provided. In the absence of an applied voltage, liquid crystal molecules contained in the liquid crystal layer 530 are oriented substantially perpendicularly to the surface of each vertical alignment film. The liquid crystal layer 530 contains a nematic liquid crystal material having negative dielectric anisotropy, and may further contain a chiral agent as necessary.

Each pixel region of the liquid crystal display device 500 has a transmission region T which presents display in the transmission mode and a reflection region R which presents display in the reflection mode. The transmission region T is defined by the transparent electrode 512t, whereas the reflection region R is defined by the reflection electrode 512r. Because of the dielectric layer 513 provided under the reflection electrode 512r, the thickness of the liquid crystal layer 530 in the reflection region R is smaller (typically about ½) than the thickness of the liquid crystal layer 530 in the transmission region T, thereby reducing the difference in the retardations which the liquid crystal layer 530 confers to light which is used for displaying in the transmission mode and to light which is used for displaying in the reflection mode. On the surface of the reflection electrode 512r, minute protrusions and depressions are provided in order to confer a diffuse reflection function to the reflection electrode 512r. Since the reflection electrode 512r has a diffuse reflection function, a white displaying state which is close to paper-white is realized.

The TFT substrate 510 further includes a wall-like structure 514 provided so as to surround the pixel electrode 512. Due to an anchoring action of its side face, the wall-like structure 514 exhibits an orientation restriction force, and this orientation restriction force defines a direction in which the liquid crystal molecules are tilted under an applied voltage. Moreover, since an oblique electric field is generated around the pixel electrode 512 under an applied voltage, the direction in which the liquid crystal molecules are tilted is also influenced by an orientation restriction force due to this oblique electric field. The direction of the orientation restriction force of the wall-like structure 514 coincides with the direction of the orientation restriction force due to the oblique electric field.

Moreover, the counter substrate 520 has protrusions 525 in regions corresponding to the substantial center of the transmission region T and the substantial center of the reflection region R. The protrusions 525 also exhibit orientation restriction forces due to the anchoring actions of their side faces.

In the liquid crystal display device 500, because the aforementioned wall-like structure 514 and protrusions 525 are provided, when a voltage is applied across the liquid crystal layer 530, a plurality of liquid crystal domains in axisymmetric orientations centered around the protrusions 525 are formed within a pixel region which is surrounded by the wall-like structure 514. FIGS. 13(a) and (b) schematically show how liquid crystal domains are created due to the orientation restriction forces of the wall-like structure 514 and the protrusions 525 in the liquid crystal display device 500.

In the absence of an applied voltage, as shown in FIG. 13(a), the liquid crystal molecules 531 are oriented substantially perpendicularly to the substrate surface due to the orientation restriction forces of the vertical alignment films. On the other hand, under an applied voltage, the liquid crystal molecules 531 having negative dielectric anisotropy fall so that their molecular major axes are perpendicular to the electric lines of force, and therefore, the directions in which the liquid crystal molecules 531 tilt are defined by the orientation restriction force of the oblique electric field generated around the pixel electrode 512 and the orientation restriction forces of the wall-like structure 514 and the protrusions 525. Hence, as shown in FIG. 13(b), the liquid crystal molecules 531 are axisymmetrically oriented, so as to be centered around the protrusions 525.

As described above, in the liquid crystal display device 500, liquid crystal domains exhibiting axisymmetric orientations are formed in each pixel region. Since liquid crystal molecules are oriented in almost all azimuthal directions (all azimuthal directions within the substrate plane) within each liquid crystal domain, excellent viewing angle characteristics are obtained.

Recently, there are rapidly increasing needs for displaying moving picture information on not only liquid crystal television sets, but also on PC monitors and mobile terminal devices (mobile phones, PDAs, etc.). In order to display moving pictures on a liquid crystal display device with a high quality, it is necessary to reduce the response time of the liquid crystal layer (make the response speed faster), and it is required to reach a predetermined gray scale level within 1 vertical scanning period (typically one frame).

As a driving method for improving the response characteristics of a liquid crystal display device, a method of applying a voltage (referred to as “overshoot voltage”) which is higher than a voltage (predetermined gray scale voltage) corresponding to a gray scale level to be displayed (referred to as “overshoot driving”) is known. By performing overshoot driving, it is possible to improve the response characteristics in gray-scale displaying.

[Patent Document 1] Japanese Laid-Open Patent Publication No. 2003-43525

[Patent Document 2] Japanese Laid-Open Patent Publication No. 2002-202511

[Patent Document 3] Japanese Laid-Open Patent Publication No. 2005-128505

[Patent Document 4] Japanese Patent No. 2955277

[Patent Document 5] The specification of U.S. Pat. No. 6,195,140

### DISCLOSURE OF INVENTION

### Problems to be Solved by the Invention

However, as has also been shown in FIG. 12(b) and the like, in a transflective type liquid crystal display device, the thickness of the liquid crystal layer in a reflection region is smaller (typically ½) than the thickness of the liquid crystal layer in a transmission region, and therefore the response speed of the reflection region is faster than the response speed of the transmission region. The reason is that, generally speaking, response speed depends on the thickness of the liquid crystal layer, such that it becomes faster as the liquid crystal layer becomes thinner. Moreover, in the case where protrusions and depressions are formed on the surface of a reflection electrode, the protrusions and depressions also contribute to an increase in the response speed of the reflection region. Thus, the reflection region and the transmission region have different response speeds, as a result of which the reflection region and the transmission region have different optimum overshoot voltages.

Therefore, when a voltage to be applied across the liquid crystal layer is set to an overshoot voltage that is optimum for the reflection region, a sufficient improvement in response speed cannot be obtained in the transmission region. On the other hand, when a voltage to be applied across the liquid crystal layer is set to an overshoot voltage that is optimum for the transmission region, degradations in display quality such as whitening (a phenomenon where luminance transiently becomes excessively high) occur in the reflection region. As described above, a transflective type liquid crystal display device can only perform an overshoot driving which is optimized with respect to only one of the transmission region and the reflection region.

The present invention has been made in view of the above problems, and an objective thereof is to, in a transflective type liquid crystal display device of a vertical alignment mode in which liquid crystal domains exhibiting axisymmetric orientations are created, reduce a difference in response speed between a region which presents display in the transmission mode and a region which presents display in the reflection mode.

### Means for Solving the Problems

A liquid crystal display device according to the present invention is a liquid crystal display device comprising a first substrate, a second substrate opposing the first substrate, and a vertical-alignment type liquid crystal layer interposed between the first substrate and the second substrate, the liquid crystal display device having a plurality of pixel regions each defined by a first electrode provided on the first substrate and a second electrode being provided on the second substrate and opposing the first electrode via the liquid crystal layer, the first substrate having a wall-like structure in regular arrangement on the liquid crystal layer side, and the liquid crystal layer forming at least one liquid crystal domain in a region substantially surrounded by the wall-like structure when a predetermined voltage is applied across the liquid crystal layer, the at least one liquid crystal domain exhibiting an axisymmetric orientation, wherein, in a region corresponding to a substantial center of the at least one liquid crystal domain, the second substrate includes at least one orientation restriction structure exhibiting an orientation restriction force for placing liquid crystal molecules in the at least one liquid crystal domain in an axisymmetric orientation at least under an applied voltage; each of the plurality of pixel regions has first and second transmission regions which present display in a transmission mode and a reflection region which presents display in a reflection mode; the first transmission region is disposed so as to contain the at least one orientation restriction structure; the second transmission region is disposed along an inner edge of the wall-like structure; and the reflection region is disposed between the first transmission region and the second transmission region.

In a preferred embodiment, the at least one orientation restriction structure is at least one protrusion projecting toward the liquid crystal layer.

In a preferred embodiment, the second substrate includes no further orientation restriction structure in the reflection region.

In a preferred embodiment, the at least one liquid crystal domain comprises a plurality of liquid crystal domains; and the at least one orientation restriction structure comprises a plurality of orientation restriction structures.

In a preferred embodiment, the first transmission region has a plurality of discrete portions, each of the plurality of portions containing one of the plurality of orientation restriction structures.

In a preferred embodiment, the reflection region is disposed also between the plurality of portions of the first transmission region.

In a preferred embodiment, the first electrode includes at least one aperture and/or recess formed in a predetermined position.

In a preferred embodiment, a thickness of the liquid crystal layer in the reflection region is smaller than a thickness of the liquid crystal layer in the first and second transmission regions.

In a preferred embodiment, the liquid crystal display device according to the present invention further comprises a driving circuit capable of applying an overshoot voltage in gray scale displaying, the overshoot voltage being higher than a predetermined gray scale voltage corresponding to a predetermined intermediate gray scale level.

### EFFECTS OF THE INVENTION

According to the present invention, in a transflective type liquid crystal display device of a vertical alignment mode in which liquid crystal domains exhibiting axisymmetric orientations are created, it is possible to reduce a difference in response speed between a region which presents display in the transmission mode and a region which presents display in the reflection mode.

### BRIEF DESCRIPTION OF DRAWINGS

FIG. 1 (a) is a plan view schematically showing the structure of one pixel region of a transflective type liquid crystal display device 100 according to a preferred embodiment of the present invention, and (b) is a cross-sectional view along line 1B-1B′ in (a).

FIG. 2 (a) and (b) are cross-sectional views along line 2A-2A′ in FIG. 1(a), where: (a) shows a state where no voltage is applied across the liquid crystal layer; and (b) shows a state where a predetermined voltage is applied across the liquid crystal layer.

FIG. 3 (a) and (b) are diagrams for describing response behavior of liquid crystal molecules in a transmission region of a conventional transflective type liquid crystal display device, where: (a) is a micrograph showing the transmission region after lapse of predetermined times since a predetermined voltage is applied across the liquid crystal layer in the absence of an applied voltage; and (b) is a diagram schematically showing the structure of the transmission region.

FIG. 4 A simulation diagram of an orientation state when a predetermined voltage is applied across the liquid crystal layer of the transflective type liquid crystal display device 100 according to a preferred embodiment of the present invention.

FIG. 5 A plan view schematically showing the structure of one pixel region of another transflective type liquid crystal display device 100A according to a preferred embodiment of the present invention.

FIG. 6 A plan view schematically showing the structure of one pixel region according to another transflective type liquid crystal display device 100B according to a preferred embodiment of the present invention.

FIG. 7 (a) is a plan view schematically showing the structure of one pixel region of another transflective type liquid crystal display device 100C according to a preferred embodiment of the present invention, and (b) is a cross-sectional view along line 7B-7B′ in (a).

FIG. 8 A plan view schematically showing the structure of one pixel region of another transflective type liquid crystal display device 100D according to a preferred embodiment of the present invention.

FIG. 9 A plan view schematically showing the structure of one pixel region of another transflective type liquid crystal display device 100E according to a preferred embodiment of the present invention.

FIG. 10 A plan view schematically showing the structure of one pixel region of another transflective type liquid crystal display device 100F according to a preferred embodiment of the present invention.

FIG. 11 (a) is a plan view schematically showing the structure of one pixel region of another transflective type liquid crystal display device 200 according to a preferred embodiment of the present invention, and (b) is a cross-sectional view along line 11B-11B′ in (a).

FIG. 12 (a) is a plan view schematically showing the structure of one pixel region of a conventional transflective type liquid crystal display device 500, and (b) is a cross-sectional view along line 12B-12B′ in (a).

FIG. 13 (a) and (b) are cross-sectional views along line 12B-12B′ in FIG. 12, where: (a) shows a state where no voltage is applied across the liquid crystal layer, and (b) shows a state where a predetermined voltage is applied across the liquid crystal layer.

### DESCRIPTION OF REFERENCE NUMERALS

T1 first transmission region
T2 second transmission region
R reflection region
10 active matrix substrate (TFT substrate)
11 transparent substrate
12 pixel electrode
12a recess
12t transparent electrode
12r reflection electrode
13 dielectric layer
14 wall-like structure
15 interlayer insulating film
20 counter substrate (color filter substrate)
21 transparent substrate
22 color filters
23 black matrix (light shielding layer)
24 counter electrode
24a aperture
25, 25′ protrusion
26 dielectric layer
30 liquid crystal layer
31 liquid crystal molecule
100, 100A, 100B, 100C liquid crystal display device
100D, 100E, 100F, 200 liquid crystal display device

### BEST MODE FOR CARRYING OUT THE INVENTION

Hereinafter, an embodiment of the present invention will be described with reference to the drawings. Note that the present invention is not limited to the following embodiment.

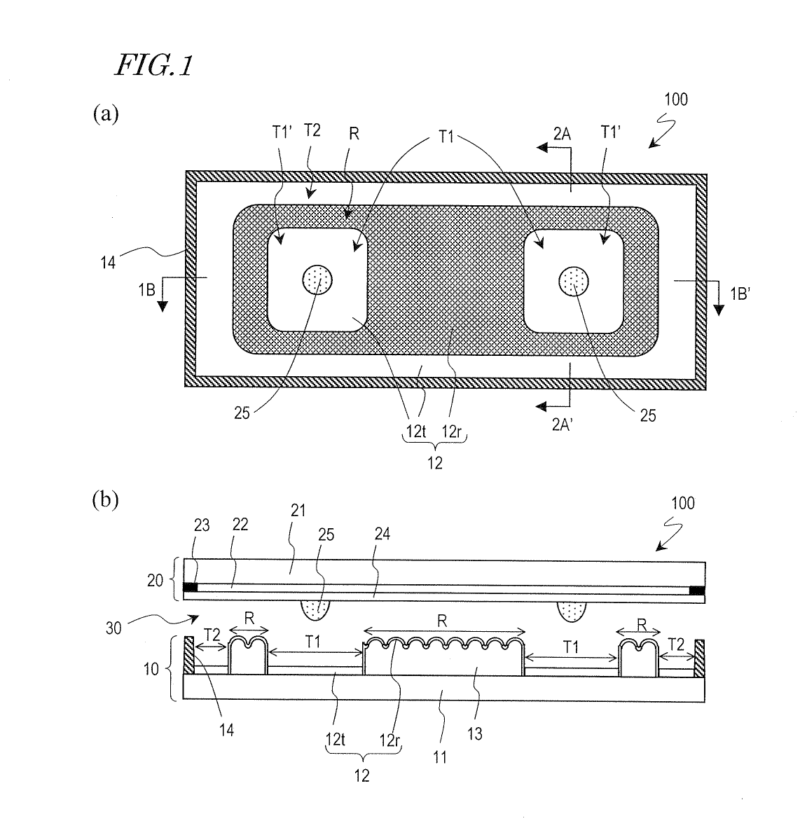

FIGS. 1(a) and (b) show a transflective type liquid crystal display device 100 according to the present embodiment. FIG. 1(a) is a plan view schematically showing the structure of one pixel region of the liquid crystal display device 100, and FIG. 1(b) is a cross-sectional view along line 1B-1B′ in FIG. 1(a).

The liquid crystal display device 100 includes an active matrix substrate (hereinafter referred to as a “TFT substrate”) 10, a counter substrate (also referred to as a “color filter substrate”) 20 opposing the TFT substrate 10, and a vertical-alignment type liquid crystal layer 30 provided between the TFT substrate 10 and the counter substrate 20.

Moreover, the liquid crystal display device 100 includes a plurality of pixel regions arranged in a matrix array. Each pixel region is defined by a pixel electrode 12 provided on the TFT substrate 10 and a counter electrode 24 which is provided on the counter substrate 20 and opposes the pixel electrode 12 via the liquid crystal layer 30.

In addition to the aforementioned pixel electrode 12, the TFT substrate 10 includes a thin film transistor (TFT) electrically connected to the pixel electrode 12, a scanning line for supplying a scanning signal to the TFT, a signal line for supplying a display signal to the TFT, and the like (none of which is shown). These component elements are formed on a transparent substrate (e.g., a glass substrate) 11. The pixel electrode 12 includes a transparent electrode 12t which is made of a transparent electrically conductive material (e.g., ITO) and a reflection electrode 12r which is made of a metal material having a high light reflectance (e.g., aluminum). As will be described later, the reflection electrode 12r is formed on a dielectric layer (which typically is a resin layer) 13. From the standpoint of realizing a white displaying state close to paper-white, it is preferable to form minute protrusions and depressions on the surface of the reflection electrode 12r as shown in FIG. 1(b), thus conferring a diffuse reflection function to the reflection electrode 12r.

In addition to the aforementioned counter electrode 24, the counter substrate 20 includes color filters 22, and a black matrix (light shielding layer) 23 provided between adjoining color filters 22. These component elements are formed on a transparent substrate (e.g., a glass substrate) 21. Although a construction in which the counter electrode 24 is provided on the color filters 22 and the black matrix 23, it is also applicable to provide the color filters 22 and the black matrix 23 on the counter electrode 24.

On a surface of each of the TFT substrate 10 and counter substrate 20 that faces the liquid crystal layer 30, a vertical alignment film (not shown) is provided. In the absence of an applied voltage, liquid crystal molecules contained in the liquid crystal layer 30 are oriented substantially perpendicularly to the surface of each vertical alignment film. The liquid crystal layer 30 contains a nematic liquid crystal material having negative dielectric anisotropy, and may further contain a chiral agent as necessary.

In the liquid crystal display device 100 of the present embodiment, the TFT substrate 10 further includes a wall-like structure 14 in regular arrangement on the liquid crystal layer 30 side. Specifically, the wall-like structure 14 is provided around the pixel electrode 12 (typically in a region which is shaded by the black matrix 23). Typically, a vertical alignment film is formed so as to cover the wall-like structure 14. Since the wall-like structure 14 as such is provided, when a predetermined voltage is applied, the liquid crystal layer 30 creates a plurality (which herein is two) of liquid crystal domains exhibiting axisymmetric orientations, within a region substantially surrounded by the wall-like structure 14.

Due to an anchoring action of its side face, the wall-like structure 14 exhibits an orientation restriction force, and this orientation restriction force defines a direction in which the liquid crystal molecules are tilted under an applied voltage. Moreover, since an oblique electric field is generated around the pixel electrode 12 under an applied voltage, the direction in which the liquid crystal molecules are tilted is also influenced by an orientation restriction force due to this oblique electric field. The wall-like structure 14 is in regular arrangement such that the direction of its orientation restriction force coincides with the direction of the orientation restriction force due to the oblique electric field. Therefore, when a voltage equal to or greater than a threshold value is applied across the liquid crystal layer 30 (i.e., between the pixel electrode 12 and the counter electrode 24), liquid crystal domains exhibiting axisymmetric orientations are stably formed within a region substantially surrounded by the wall-like structure 14. Although the orientation restriction force due to the oblique electric field decreases as the voltage decreases, the orientation restriction force due to the wall-like structure 14 does not depend on voltage, and therefore stably defines the direction in which the liquid crystal molecules are tilted, also in a gray-scale displaying state.

In each liquid crystal domain, the liquid crystal molecules are oriented in almost all azimuthal directions (all azimuthal directions within the substrate plane), so that the liquid crystal display device 100 of the present embodiment has excellent viewing angle characteristics. Herein, “axisymmetric orientation” is synonymous with “radially-inclined orientation” as used in Patent Documents 1 and 2. Around the center axis of axisymmetric orientation (center axis of radially-inclined orientation), the liquid crystal molecules are continuously oriented without forming disclination lines, and the major axes of the liquid crystal molecules are oriented in a radial, tangential, or spiral manner. In either case, the major axes of the liquid crystal molecules have components which are radially-inclined from the center of orientation (components which are parallel to the oblique electric field).

Note that a “region substantially surrounded by” the wall-like structure 14 may be any region such that the wall-like structure 14 is able to create liquid crystal domains by continuously exerting an orientation restriction force on the liquid crystal molecules within the region, and it is not necessary that the wall-like structure 14 completely surrounds the region in the physical sense. Although the wall-like structure 14 is illustrated herein as a continuous wall which surrounds a pixel, the wall-like structure 14 may be split into a plurality of walls. However, since the wall-like structure 14 acts to define a boundary to be formed near the outer periphery of the pixel region of each liquid crystal domain, it is preferable that the wall-like structure 14 has a certain length or more. For example, in the case where the wall-like structure 14 is composed of a plurality of walls, it is preferable that the length of each wall is longer than the length between adjoining walls. Moreover, when the wall-like structure 14 is disposed in a light-shielding region as in the present embodiment, the wall-like structure 14 itself will not unfavorably affect displaying.

In the liquid crystal display device 100 of the present embodiment, the counter substrate 20 further includes a protrusion 25 provided in a region corresponding to the substantial center of each liquid crystal domain. Due to an anchoring action of its surface, the protrusion 25 projecting toward the liquid crystal layer 30 has an orientation restriction force which places the liquid crystal molecules within the liquid crystal domain in an axisymmetric orientation. By providing such protrusions 25, the center axes of axisymmetric orientation of the liquid crystal domains can be fixed and stabilized.

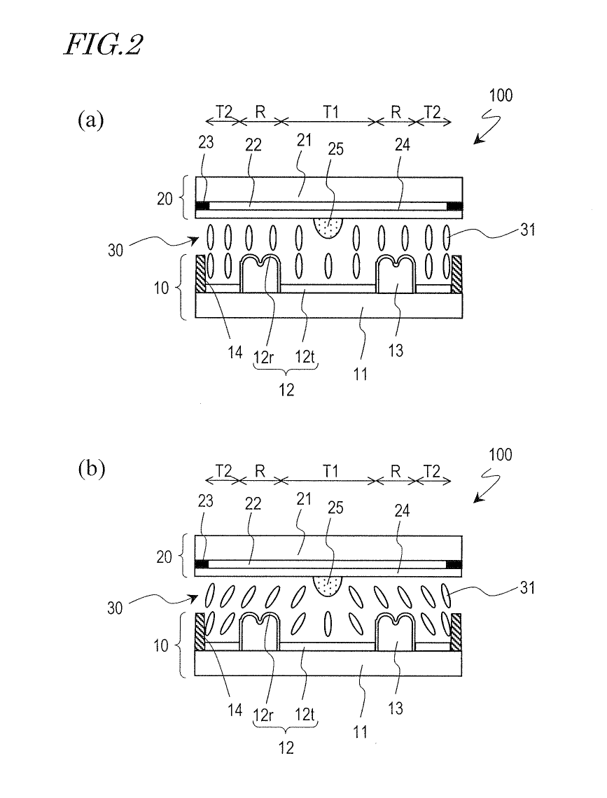

FIGS. 2(a) and (b) schematically show how liquid crystal domains are created due to the orientation restriction forces of the wall-like structure 14 and the protrusions 25 in the liquid crystal display device 100.

In the absence of an applied voltage, as shown in FIG. 2(a), the liquid crystal molecules 31 are oriented substantially perpendicularly to the substrate surface due to the orientation restriction forces of the vertical alignment films. Strictly speaking, however, the liquid crystal molecules 31 near the wall-like structure 14 and near the protrusions 25 are oriented substantially perpendicularly to the surfaces of the wall-like structure 14 and the protrusions 25, and are not substantially perpendicular to the substrate surface.

On the other hand, under an applied voltage, the liquid crystal molecules 31 having negative dielectric anisotropy fall so that their molecular major axes are perpendicular to the electric lines of force. As a result, the direction in which the liquid crystal molecules 31 are tilted is defined by the orientation restriction force of the oblique electric field generated around the pixel electrode 12 and the orientation restriction forces of the wall-like structure 14 and the protrusions 25. Therefore, as shown in FIG. 2(b), the liquid crystal molecules 31 are oriented axisymmetrically, so as to be centered around the protrusions 25.

As described above, in the liquid crystal display device 100, liquid crystal domains having axisymmetric orientations are created in each pixel, whereby excellent viewing angle characteristics are obtained. Each pixel of the transflective type liquid crystal display device 100 has a region which presents display in the reflection mode by using light (ambient light) that enters the liquid crystal layer 30 from the counter substrate 20 side and a region which presents display in the transmission mode by using light entering the liquid crystal layer 30 from the TFT substrate 10 side (light from a backlight). However, the positioning of these two kinds of regions in the liquid crystal display device 100 of the present embodiment greatly differs from that in a conventional liquid crystal display device. Hereinafter, referring back to FIG. 1, the positioning of these regions in the liquid crystal display device 100 will be specifically described.

As shown in FIG. 1, each pixel region of the liquid crystal display device 100 includes: a first transmission region T1 and a second transmission region T2 which present display in the transmission mode; and a reflection region R which presents display in the reflection mode. The first transmission region T1 and the second transmission region T2 are defined by the transparent electrode 12t of the pixel electrode 12. On the other hand, the reflection region R is defined by the reflection electrode 12r of the pixel electrode 12.

The reflection electrode 12r is formed on the dielectric layer 13, which is selectively formed in the reflection region R. As a result of this, the cell gap in the reflection region R (thickness of the liquid crystal layer 30) is smaller than the cell gap in the first transmission region T1 and the second transmission region T2. In the transmission mode displaying, the light used for displaying passes through the liquid crystal layer 30 only once, whereas in the reflection mode displaying, the light used for displaying passes through the liquid crystal layer 30 twice. Therefore, it is preferable to prescribe the cell gap of the reflection region R to be smaller than the cell gap in the first transmission region T1 and the second transmission region T2. By so prescribing, the difference between retardations which are conferred to both display modes of light by the liquid crystal layer 30 can be made small. Specifically, the cell gap in the reflection region R is preferably no less than 0.3 times and no more than 0.7 times, and most preferably about 0.5 times (½ times), of the cell gap in the first transmission region T1 and the second transmission region T2.

The first transmission region T1 is disposed so as to contain the protrusions 25, which are orientation restriction structures. In the present embodiment, the first transmission region T1 includes a plurality of discrete portions T1′, such that each of these portions T1′ includes one protrusion 25.

The second transmission region T2 is disposed along the inner edge of the wall-like structure 14. In other words, the second transmission region T2 is disposed along the edge portion of the pixel electrode 12.

On the other hand, the reflection region R is disposed between the first transmission region T1 and the second transmission region T2. Moreover, the reflection region R is also disposed between the plurality of portions T1′ composing the first transmission region T1. That is, the reflection region R is disposed so as to surround the first transmission region T1 and be surrounded by the second transmission region T2.

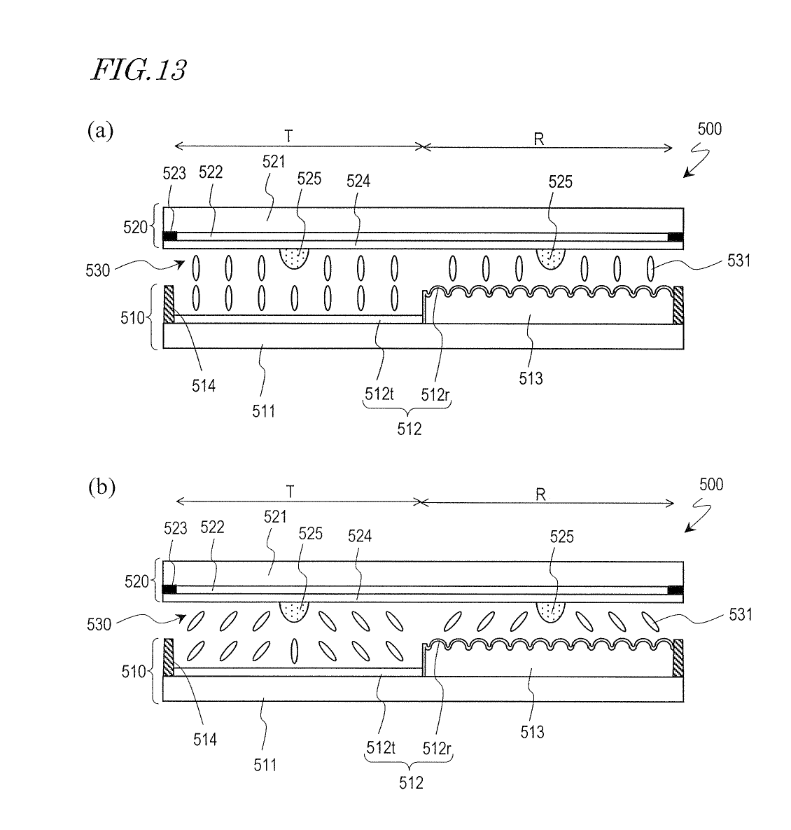

Therefore, when a voltage is applied across the liquid crystal layer 30, as shown in FIG. 2(b), each liquid crystal domain is formed astride the first transmission region T1, the reflection region R, and the second transmission region T2, so as to be centered around the protrusion 25. On the other hand, in the conventional liquid crystal display device 500 as shown in FIG. 12, each liquid crystal domain is entirely formed in either only the reflection region R or the transmission region T, as shown in FIG. 13(b). That is, it is not the case that one liquid crystal domain is formed astride a plurality of regions of different display modes.

As described above, in the liquid crystal display device 100 of the present embodiment, the reflection region R is disposed between the first transmission region T1, which is disposed so as to contain the protrusions 25, and the second transmission region T2, which is disposed along the inner edge of the wall-like structure 14. That is, in the liquid crystal display device 100, neighborhoods of the protrusions 25 and the wall-like structure 14, i.e., regions which are directly susceptible to the orientation restriction forces of the protrusions 25 and the wall-like structure 14, are used for the transmission mode displaying, whereas regions distant from the protrusions 25 and the wall-like structure 14, i.e., regions which are not directly susceptible to the orientation restriction forces of the protrusions 25 and the wall-like structure 14, are used for the reflection mode displaying. Therefore, the influence which the difference in cell gap exerts on the response speed can be counteracted by the influence which the distance from the protrusions 25 and the wall-like structure 14 exerts on the response speed, whereby the difference between the response speed in the reflection region R and response speed in the first transmission region T1 and the second transmission region T2 can be reduced. As a result, in the liquid crystal display device 100, it is possible to perform an overshoot driving which is optimized with respect to both the first transmission region T1 and second transmission region T2 and the reflection region R. Therefore, while suppressing deteriorations in display quality in the reflection region R (occurrence of whitening, etc.), the response speed in the first transmission region T1 and the second transmission region T2 can be sufficiently improved.

Note that, known methods are broadly applicable to realize overshoot driving. For example, a driving circuit which is capable of applying an overshoot voltage (a gray scale voltage may be used) which is higher than a predetermined gray scale voltage corresponding to a predetermined intermediate gray scale level may be provided, or overshoot driving may be conducted by software means.

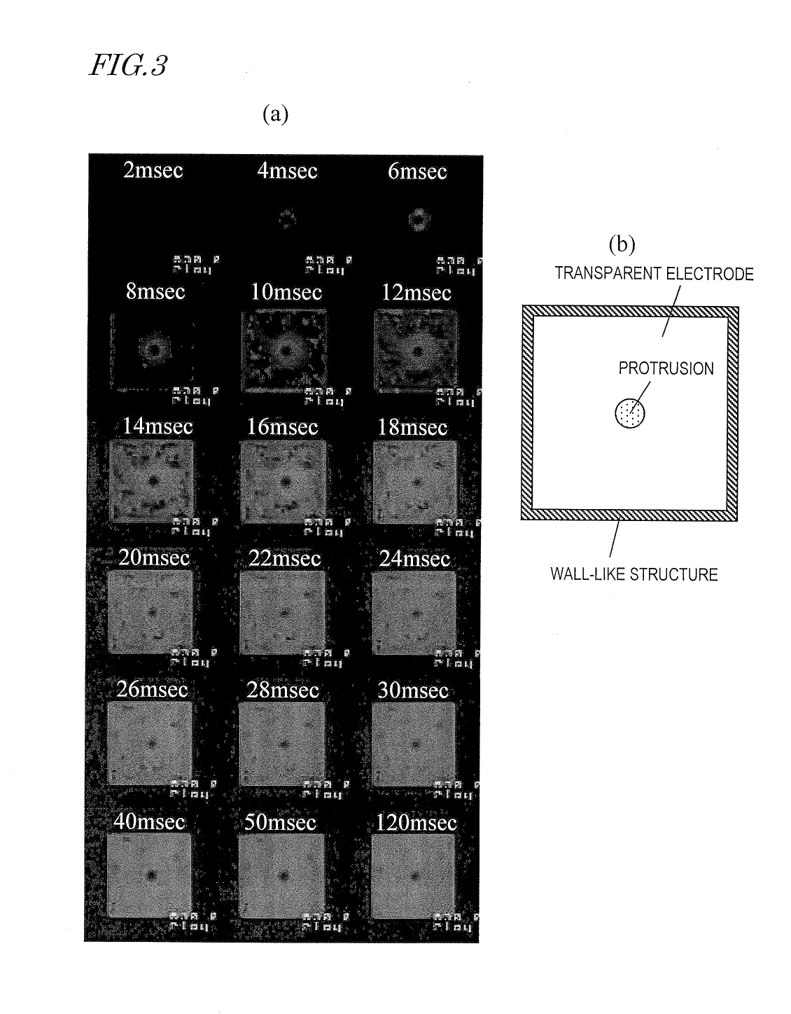

FIG. 3 shows response behavior of liquid crystal molecules in a transmission region of a conventional transflective type liquid crystal display device. FIG. 3(a) is a micrograph showing the transmission region after lapse of predetermined times since a predetermined voltage is applied to the liquid crystal layer in the absence of an applied voltage (black displaying state), and FIG. 3(b) is a diagram schematically showing the structure of this transmission region.

As shown in FIG. 3(a), immediately after voltage application, the region near the protrusion and the region near the wall-like structure become bright first, and then the region therebetween becomes gradually brighter. This indicates that, in the case where the cell gap is constant, the response speeds of the region near the protrusion and the region near the wall-like structure are fast, whereas the response speed of the region therebetween is slow.

On the other hand, in the liquid crystal display device 100 of the present embodiment, the region near each protrusion 25 and the region near the wall-like structure 14 are used for the transmission mode displaying, and the region therebetween is used for the reflection mode displaying, thereby reducing the difference in response speed based on whether the distance from the structures exhibiting orientation restriction forces (the protrusions 25 and the wall-like structure 14) is long or short.

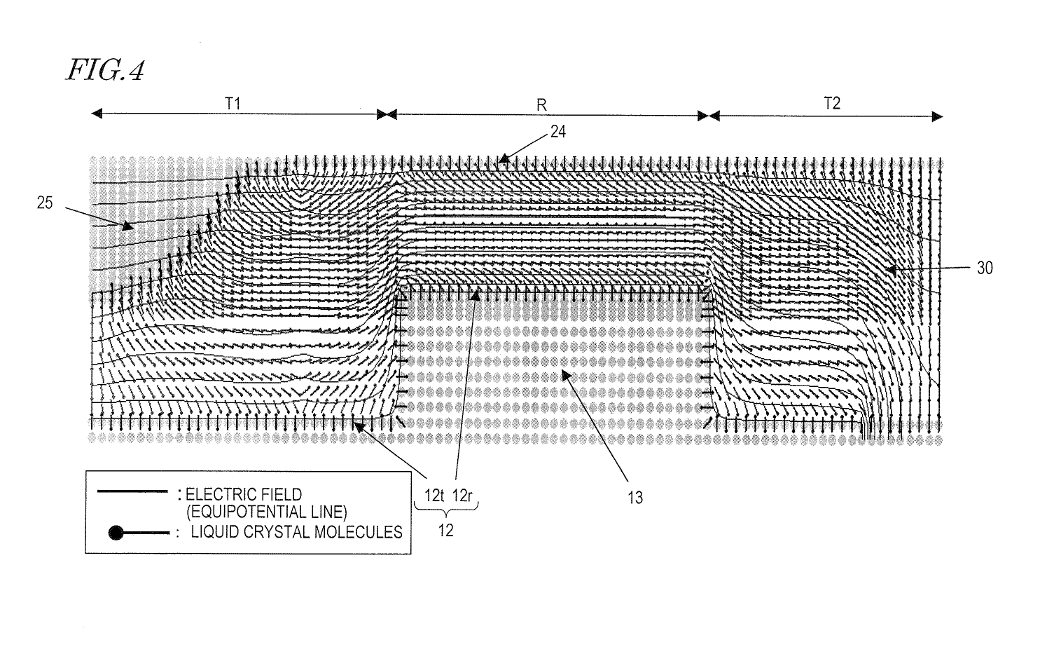

In the liquid crystal display device 100 of the present embodiment, as has already been described, each liquid crystal domain is formed astride the first transmission region T1, the reflection region R, and the second transmission region T2. Note that liquid crystal domain formation suitably occurs even if a single liquid crystal domain extends astride a plurality of regions having different cell gaps. FIG. 4 is a simulation diagram of an orientation state when a predetermined voltage is applied across the liquid crystal layer 30. As can be seen from FIG. 4, under an applied voltage, a liquid crystal domain extending astride the first transmission region T1, the reflection region R, and the second transmission region T2 is created.

In the present embodiment, two liquid crystal domains are created in one pixel region under an applied voltage; however, the present invention is not limited thereto. Three or more liquid crystal domains may be created, or only one liquid crystal domain may be created. In other words, at least one liquid crystal domain may be created in the pixel region under an applied voltage.

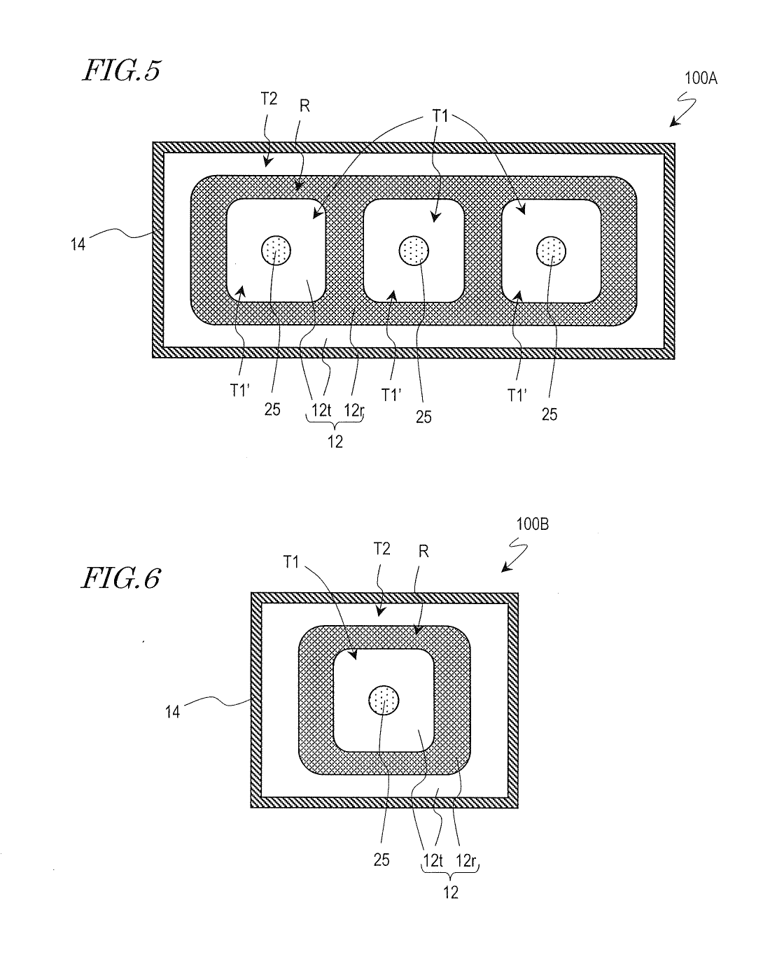

FIG. 5 and FIG. 6 show liquid crystal display devices 100A and 100B in which the number of liquid crystal domains to be created in a pixel region is different from that of the liquid crystal display device 100 shown in FIG. 1. In the liquid crystal display device 100A shown in FIG. 5, three protrusions 25 are provided in a pixel region, and three liquid crystal domains are created under an applied voltage, so as to be centered around the respective protrusions 25. In the liquid crystal display device 100B shown in FIG. 6, only one protrusion 25 is provided in a pixel region, and one liquid crystal domain is created under an applied voltage, so as to be centered around the protrusion 25. In the liquid crystal display devices 100A and 100B shown in FIG. 5 and FIG. 6, too, since the reflection region R is disposed between the first transmission region T1 and the second transmission region T2, effects similar to those of the liquid crystal display device 100 shown in FIG. 1 and the like are obtained.

Note that, in the case where a plurality of liquid crystal domains are created within a pixel region (i.e., a plurality of protrusions 25 are provided within a pixel region), as in the liquid crystal display device 100 shown in FIG. 1 and the liquid crystal display device 100A shown in FIG. 5, it is preferable to compose the first transmission region T1 from a plurality of discrete portions T1′ and allow the reflection region R to be disposed also between the plurality of portions T1′, as is shown. The reason is that, when a plurality of protrusions 25 are provided, depending on their pitch, it may be difficult for the orientation restriction forces of the protrusions 25 to reach the liquid crystal layer 30 in a region near the middle of the two adjoining protrusions 25.

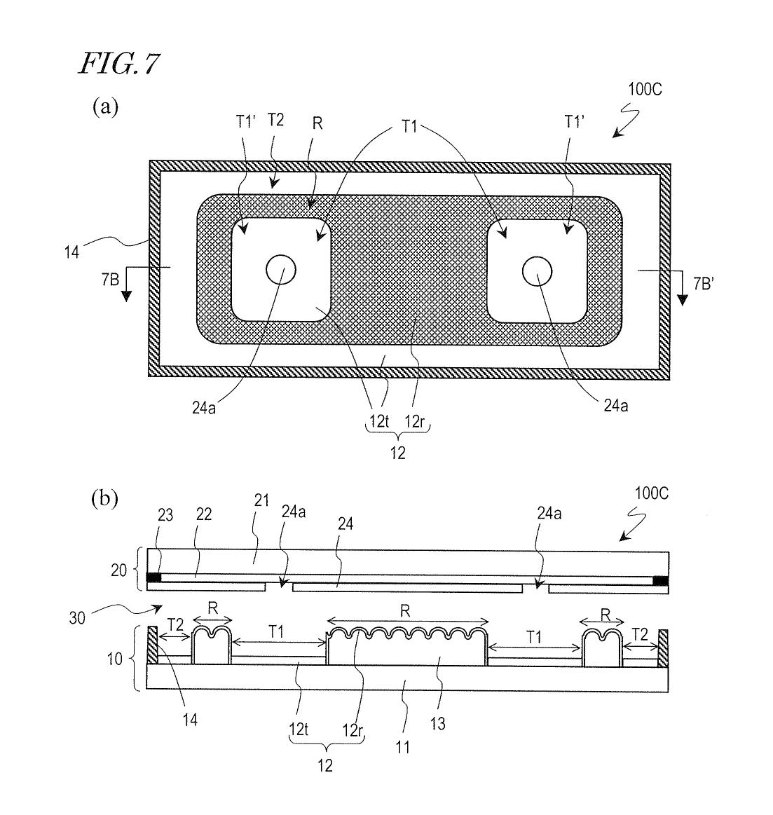

Although the present embodiment illustrates a construction in which the protrusions 25 are provided on the counter substrate 20, the present invention is not limited thereto. On the counter substrate 20, any orientation restriction structure may be provided that exhibits an orientation restriction force at least under an applied voltage. FIGS. 7(a) and (b) show a liquid crystal display device 100C having orientation restriction structures different from the protrusions 25. FIG. 7(a) is a plan view schematically showing the structure of one pixel region of the liquid crystal display device 100C, and FIG. 7(b) is a cross-sectional view along line 7B-7B′ in FIG. 7(a).

In the liquid crystal display device 100C, apertures 24a are formed in the counter electrode 24 of the counter substrate 20. Similarly to the protrusions 25, the apertures 24a are provided in regions corresponding to the substantial centers of liquid crystal domains. When a voltage is applied across the liquid crystal layer 30, an oblique electric field is generated within each aperture 24a, such that the oblique electric field acts to place the liquid crystal molecules in the liquid crystal domain in an axisymmetric orientation. That is, the apertures 24a in the counter electrode 24 exhibit orientation restriction forces for placing the liquid crystal molecules in each liquid crystal domain in an axisymmetric orientation under an applied voltage. Thus, in the liquid crystal display device 100C, the apertures 24a in the counter electrode 24 function as orientation restriction structures.

Since the apertures 24a do not exhibit orientation restriction forces in the absence of an applied voltage, using the apertures 24a in the counter electrode 24 as orientation restriction structures prevents leakage of light in a black displaying state, thus improving the contrast ratio. On the other hand, the protrusions 25 exhibit orientation restriction forces even in the absence of an applied voltage, too (i.e., they perform orientation restriction irrespective of the level of the applied voltage), using the protrusions 25 as orientation restriction structures makes it possible to realize sufficiently stable axisymmetric orientations even in a gray-scale displaying state with a low applied voltage.

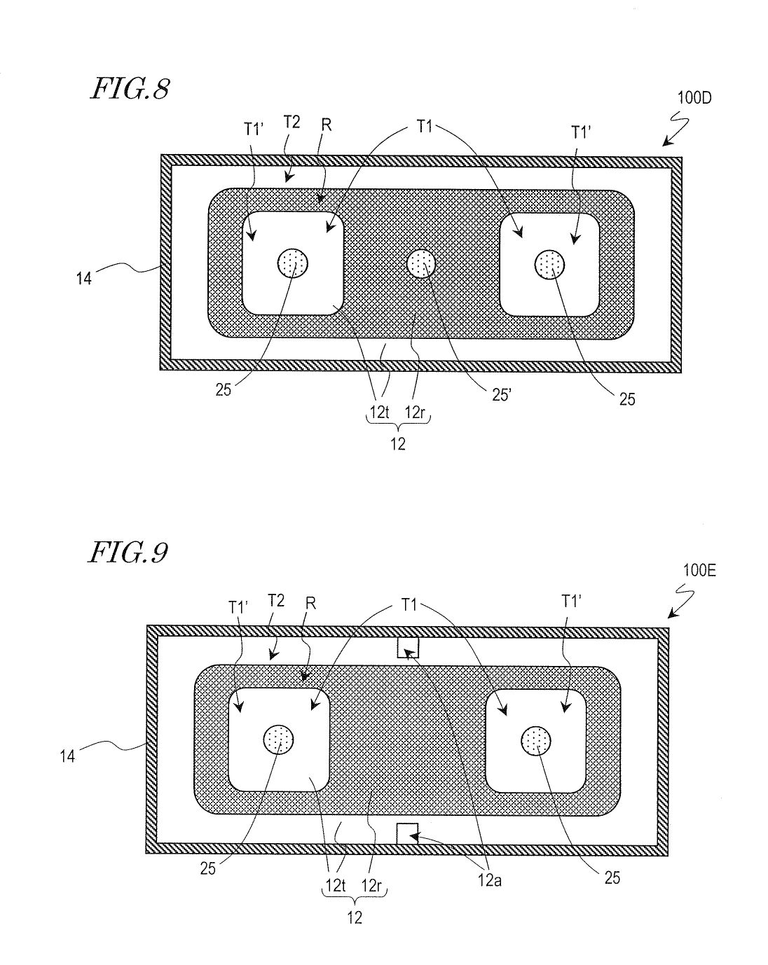

The above description is directed to a construction where the counter substrate 20 does not include any orientation restriction structures in the reflection region R (further orientation restriction structures other than the protrusions 25 or apertures 24a provided in the first transmission region T1), a further orientation restriction structure may be provided in the reflection region R as necessary, as shown in FIG. 8.

A liquid crystal display device 100D shown in FIG. 8 includes a protrusion 25′ in the reflection region R, as a further orientation restriction structure. Within the reflection region R, the protrusion 25′ is provided in a region that is the farthest from the protrusions 25 in the first transmission region T1 and from the wall-like structure 14. Depending on the size of the reflection region R, the response characteristics may not be sufficient in a portion (a region which is distant from the protrusions 25 in the first transmission region T1 and the wall-like structure 14) of the reflection region R. However, by providing a further orientation restriction structure in the reflection region R, sufficient response characteristics can be obtained even when the reflection region R is large. Note that, in the construction shown in FIG. 8, three liquid crystal domains will be created so as to be centered around the orientation restriction structures (two protrusions 25) in the first transmission region T1 and around the further orientation restriction structure (one protrusion 25′) in the reflection region R.

Next, more specific structures and preferable structures for the pixel electrode 12 and the wall-like structure 14 will be described.

In order to better stabilize the axisymmetric orientation of a liquid crystal domain, it is preferable that the pixel electrode 12 includes at least one aperture and/or recess which is formed in a predetermined position. An example of a liquid crystal display device having such a pixel electrode 12 is shown in FIG. 9.

A pixel electrode 12 of a liquid crystal display device 100E shown in FIG. 9 includes a pair of rectangular recesses 12a. The recesses 12a are disposed near the boundary between two liquid crystal domains which are created under an applied voltage. By providing such recesses 12a, the axisymmetric orientations in the liquid crystal domains can be better stabilized due to oblique electric fields that are generated in the recesses 12a under an applied voltage. It will be appreciated that, instead of (or in addition to) the recesses 12a, apertures may be provided in the pixel electrode 12 to obtain similar effects.

The wall-like structure 14 is made of a dielectric material (which typically is a resin material). If the wall-like structure 14 is formed by using the same material and through the same step (i.e., simultaneously) as the dielectric layer 13 for forming multigaps, the wall-like structure 14 can be formed without increasing the number of production steps.

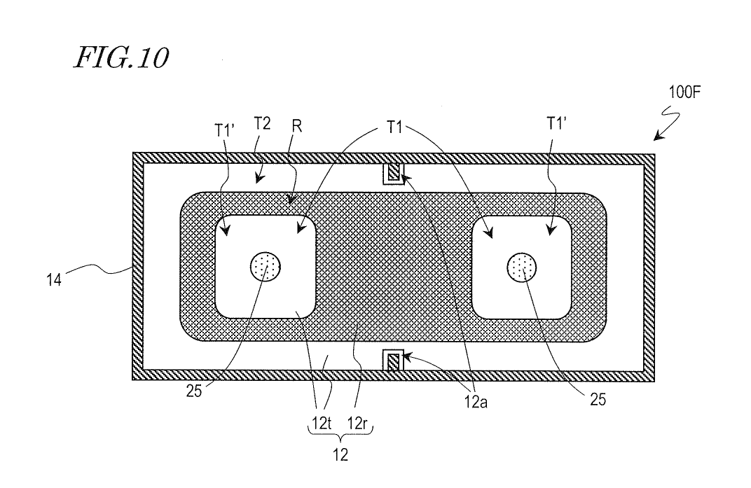

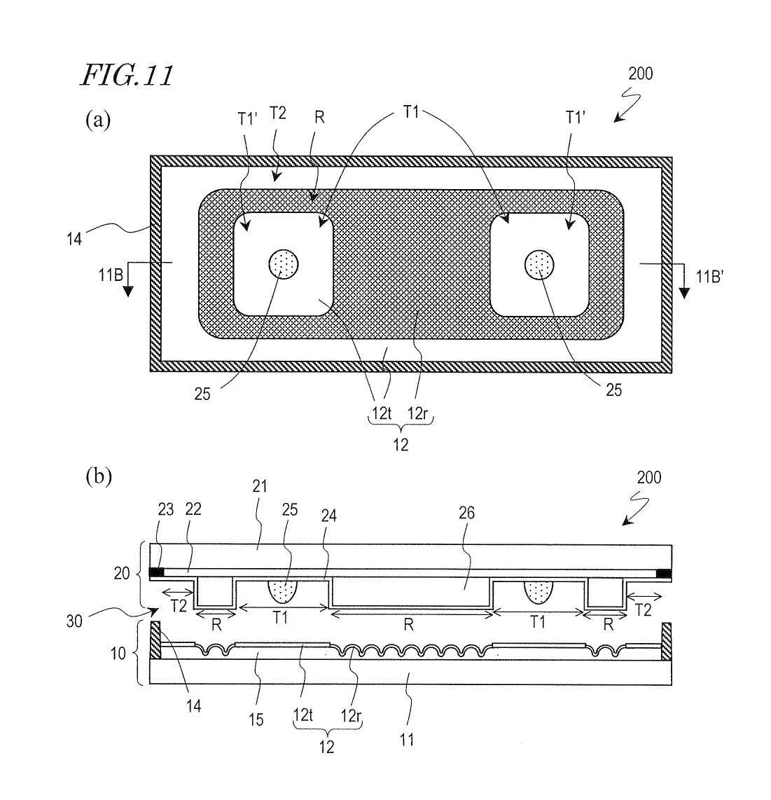

The wall-like structure 14 is not limited to the shape illustrated in FIG. 1 and the like. For example, as has already been discussed, the wall-like structure 14 may be split into a plurality of walls, instead of being a continuous wall. Moreover, as in a liquid crystal display device 100F shown in FIG. 10, the wall-like structure 14 may be disposed in the recesses 12a (or apertures) of the pixel electrode 12 as well. By allowing a wall-like structure 14 of a shape substantially similar to a recess 12a to be disposed in the recess 12a (e.g., disposing a rectangular wall-like structure 14 in a rectangular recess 12a), the effect of stabilizing the orientations in the liquid crystal domains can be further enhanced because the orientation restriction force due to an oblique electric field generated in the recess 12a under an applied voltage matches the orientation restriction force of the wall-like structure 14 in the recess 12a.

There are no particular limits to the height of the wall-like structure 14. However, if the wall-like structure 14 is too low, the orientation restriction force due to the wall-like structure 14 becomes weak, so that a stable orientation state may not be obtained. If the wall-like structure 14 is too high, when injecting a liquid crystal material in between the TFT substrate 10 and the counter substrate 20, the wall-like structure 14 may hinder the injection of the liquid crystal material, so that the time required for injection may be prolonged or regions of incomplete injection may occur. Therefore, it is preferable to set the height of the wall-like structure 14 by taking into consideration the desired intensity of orientation restriction force and ease of injection of the liquid crystal material.

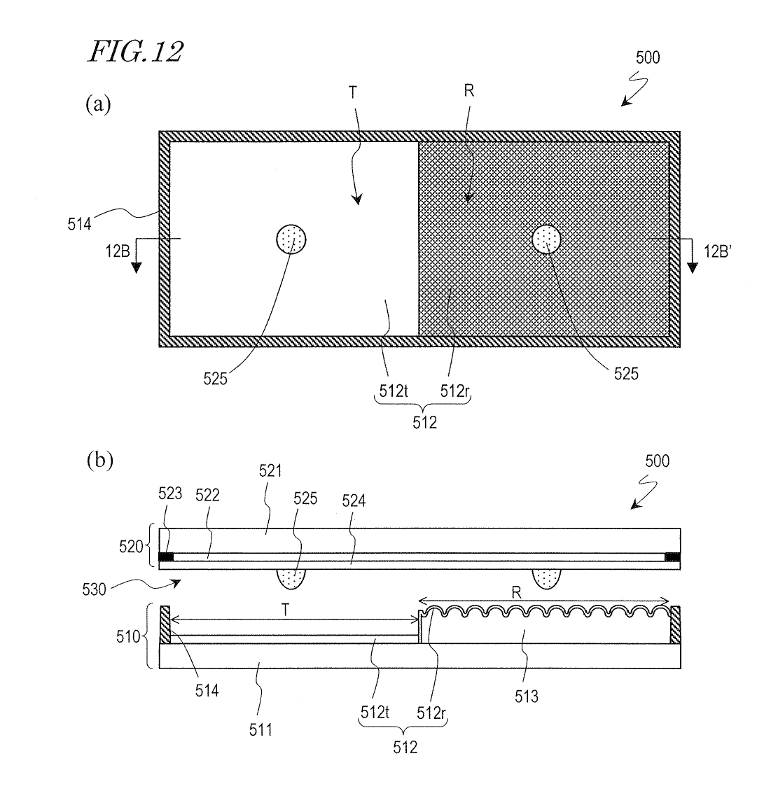

Although the above description is directed to a construction in which stepped portions for creating multigaps are provided on the TFT substrate 10, a construction (counter multigap structure) in which stepped portions are provided on the counter substrate 20 may be adopted. FIGS. 11(a) and (b) schematically show a liquid crystal display device 200 having a counter multigap structure. FIG. 11(a) is a plan view schematically showing the structure of one pixel region of the liquid crystal display device 200, and FIG. 11(b) is a cross-sectional view along line 11B-11B′ in FIG. 11(a).

The transparent electrode 12t and the reflection electrode 12r of the pixel electrode 12 of the liquid crystal display device 200 are formed on an interlayer insulating film 15 which is formed across the entire pixel region, and are at substantially the same height. Moreover, the counter substrate 20 has a dielectric layer 26 which is selectively formed in the reflection region R such that the dielectric layer 26 creates multigaps.

In the liquid crystal display device 200, too, the reflection region R is disposed between the first transmission region T1, which is disposed so as to contain orientation restriction structures (protrusions 25), and the second transmission region T2, which is disposed along the inner edge of the wall-like structure 14. Therefore, it is possible to perform an overshoot driving which is optimized with respect to both the first transmission region T1 and second transmission region T2 and the reflection region R.

### INDUSTRIAL APPLICABILITY

According to the present invention, in a transflective type liquid crystal display device of a vertical alignment mode in which liquid crystal domains exhibiting axisymmetric orientations are created, it is possible to reduce a difference in response speed between a region which presents display in the transmission mode and a region which presents display in the reflection mode. Therefore, an overshoot driving which is optimized with respect to both regions can be performed. Therefore, while suppressing deteriorations in display quality in the region which presents display in the reflection mode (occurrence of whitening, etc.), the response speed in the region which presents display in the transmission mode can be sufficiently improved.

1. A liquid crystal display device comprising:
a first substrate, a second substrate opposing the first substrate, and a vertical-alignment type liquid crystal layer interposed between the first substrate and the second substrate,
the liquid crystal display device having a plurality of pixel regions each defined by a first electrode provided on the first substrate and a second electrode being provided on the second substrate and opposing the first electrode via the liquid crystal layer,
the first substrate having a wall-like structure in regular arrangement on the liquid crystal layer side, and
the liquid crystal layer forming at least one liquid crystal domain in a region substantially surrounded by the wall-like structure when a predetermined voltage is applied across the liquid crystal layer, the at least one liquid crystal domain exhibiting an axisymmetric orientation, wherein,
in a region corresponding to a substantial center of the at least one liquid crystal domain, the second substrate includes at least one orientation restriction structure exhibiting an orientation restriction force for placing liquid crystal molecules in the at least one liquid crystal domain in an axisymmetric orientation at least under an applied voltage;
each of the plurality of pixel regions has first and second transmission regions which present display in a transmission mode and a reflection region which presents display in a reflection mode;
the first transmission region is disposed so as to contain the at least one orientation restriction structure;
the second transmission region is disposed along an inner edge of the wall-like structure; and
the reflection region is disposed between the first transmission region and the second transmission region.

2. The liquid crystal display device of claim 1, wherein the at least one orientation restriction structure is at least one protrusion projecting toward the liquid crystal layer.

3. The liquid crystal display device of claim 1, wherein the second substrate includes no further orientation restriction structure in the reflection region.

4. The liquid crystal display device of claim 1, wherein, the at least one liquid crystal domain comprises a plurality of liquid crystal domains; and the at least one orientation restriction structure comprises a plurality of orientation restriction structures.

5. The liquid crystal display device of claim 4, wherein the first transmission region has a plurality of discrete portions, each of the plurality of portions containing one of the plurality of orientation restriction structures.

6. The liquid crystal display device of claim 5, wherein the reflection region is disposed also between the plurality of portions of the first transmission region.

7. The liquid crystal display device of claim 1, wherein the first electrode includes at least one aperture and/or recess formed in a predetermined position.

8. The liquid crystal display device of claim 1, wherein a thickness of the liquid crystal layer in the reflection region is smaller than a thickness of the liquid crystal layer in the first and second transmission regions.

9. The liquid crystal display device of claim 1, further comprising a driving circuit capable of applying an overshoot voltage in gray scale displaying, the overshoot voltage being higher than a predetermined gray scale voltage corresponding to a predetermined intermediate gray scale level.
